(19) United States
(12) Patent Application Publication
(10) Pub. No.: US 2024/0336462 A1
(43) Pub. Date: Oct. 10, 2024

(54) IMAGE ANALYSIS-BASED FORKLIFT INTERFACE PROVIDING DEVICE AND METHOD OF OPERATING SAME

(71) Applicant: PINE S&S INC., Daejeon (KR)

(72) Inventor: Hee Sung CHAE, Daejeon (KR)

(21) Appl. No.: 18/682,102

(22) PCT Filed: Aug. 31, 2022
(86) PCT No.: PCT/KR2022/013057

§ 371 Date: Feb. 7, 2024

(30) Foreign Application Priority Data
Aug. 31, 2021 (KR) 10-2021-0115497
Oct. 1, 2021 (KR) 10-2021-0130941

(51) Int. Cl. B66F 9/075; G06V 10/75; G06V 20/56

(52) U.S. Cl. CPC B66F 9/0755; G06V 10/751; G06V 20/56

(57) ABSTRACT

A forklift interface providing device according to an embodiment of the present disclosure may include a fork camera provided in a fork of a forklift; a guide interface generation unit that constructs fork image information of the fork camera into a guide interface; a distance information calculation unit that calculates distance information to a target object from pixel information of the fork image information; and an output unit that outputs the guide interface using the distance information.

### TECHNICAL FIELD

The present disclosure relates to a fork control device for a forklift and a method of operating the same. More specifically, the present disclosure relates to an image analysis-based forklift interface providing device and a method of operating the same.

### BACKGROUND ART

In general, a vehicle that performs special-purpose operations, such as a forklift, a sweeper or the like, is equipped with a system that detects the presence of an object in the surrounding area using a device such as a sensor or a camera to prevent an accident from occurring during operation. For instance, when detecting a person in a certain area using an infrared sensor, the system may emit a warning sound to cause a driver of the vehicle to stop operating or allow people therearound to avoid themselves.

However, in the case of a forklift, when moving an object while placed on a pallet, blind spots often occur in the front view due to a volume of the object, and thus there is a problem in which the operator cannot directly check the front view. To prevent this, a partner who controls a situation around the forklift and a forklift operator slowly perform an operation while communicating with each other, and in this case, there is a disadvantage in that the operation progresses somewhat slowly.

In order to solve the above problem, Korean Patent Registration No. 10-2063957 or the like has proposed a technology for mounting a plurality of cameras on a forklift, and combining images to monitor blind spots or the like through an image combination such as around view monitoring.

However, each fork structure of a forklift has a different detailed specification and shape depending on the manufacturer. In particular, the shapes and positions of forks and forklifts may all differ from one another in detail. Therefore, when a plurality of cameras are placed at specific positions of a forklift, different images may be output for respective forklifts, and a quite unnatural image may be output from a specific forklift.

In order to correct this, a process of measuring all relative positions and heights of respective cameras and identifying and aligning their relationships or the like must be carried out, and an inconvenience of having to reflect it in a different manner for each forklift inevitably arises.

In addition, a fork type, a fork spacing, a lift design, a frame structure, and the like may all be different for each forklift, and thus there is a problem in that a distance to a target pallet, or the like cannot be accurately determined using only an image from an image camera mounted on a fork or the like.

Accordingly, with current technologies, due to a difference in specification for each forklift, the forklift must be operated while viewing an image that is completely different from actual distance recognition, which can lead to various problems such as safety issues and poor operation.

### DISCLOSURE OF INVENTION

### Technical Problem

The present disclosure is contrived to solve the foregoing problems, and an aspect of the present disclosure is to provide an image analysis-based forklift control device that performs image prediction correction based on forklift specification database information on an image of a fork camera provided in a forklift, and analyzes the corrected image to display a forklift guide interface based on accurate distance information so as to prevent an error in advance due to an image distortion or difference in forklift specification and enable convenient and accurate control using the forklift guide interface, and a method of operating the same.

### Technical Solution

In order to solve the foregoing problems, according to an embodiment of the present disclosure, there is provided a forklift interface providing device, the device including: a fork camera provided in a fork of a forklift; a guide interface generation unit that constructs fork image information of the fork camera into a guide interface; a distance information calculation unit that calculates distance information to a target object from pixel information of the fork image information; and an output unit that outputs the guide interface including the distance information.

In addition, in order to solve the foregoing problems, according to an embodiment of the present disclosure, there is provided a method of operating a forklift interface providing device, the method including: constructing fork image information of a fork camera provided in a fork of a forklift into a guide interface; calculating distance information to a target object from pixel information of the fork image information; and outputting the guide interface including the distance information.

Moreover, in order to solve the foregoing problems, a method according to an embodiment of the present disclosure may be configured with a program for executing the method on a computer, and a computer-readable recording medium on which the program is recorded.

### Advantageous Effects

According to an embodiment of the present disclosure, there may be provided an image analysis-based forklift control device that performs image prediction correction based on forklift specification database information on an image of a fork camera provided in a forklift, and analyzes the corrected image to display a forklift guide interface based on accurate distance information so as to prevent an error in advance due to an image distortion or difference in forklift specification and enable convenient and accurate control using the forklift guide interface, and a method of operating the same.

### BRIEF DESCRIPTION OF THE DRAWINGS

FIG. 1 is a diagram showing a forklift mounted with an image analysis-based forklift interface providing device according to an embodiment of the present disclosure.

FIG. 2 is a block diagram for explaining in more detail an image analysis-based forklift interface providing device according to an embodiment of the present disclosure.

FIG. 3 is a flowchart for explaining in more detail an operation of an image analysis-based forklift interface providing device according to an embodiment of the present disclosure.

FIGS. 4 and 5 are diagrams for explaining a distance calculation process of an image analysis-based forklift interface providing device according to an embodiment of the present disclosure.

FIGS. 6 and 7 are exemplary diagrams of image analysis-based forklift guide interface screens according to an embodiment of the present disclosure.

FIG. 8 is a flowchart for explaining an operation of an image analysis-based forklift interface providing device based on image analysis according to another embodiment of the present disclosure, and FIGS. 9 to 12 are exemplary diagrams of forklift guide interface screens for respective steps corresponding thereto.

FIGS. 13 and 14 are diagrams for explaining a distance calculation process of an image analysis-based forklift interface providing device according to another embodiment of the present disclosure.

### BEST MODE FOR CARRYING OUT THE INVENTION

The following description illustrates the principles of the present disclosure. It will thus be appreciated that those skilled in the art will be able to devise various devices that, although not explicitly described or shown in this specification, implement the principles of the present disclosure and are included in the concept and scope of the present disclosure. Furthermore, it should be understood that all conditional terms and embodiments recited in this specification are intended only for pedagogical purposes to aid the reader in understanding the concept of the present disclosure, and are not limited to such specifically recited embodiments and conditions.

Moreover, it should be understood that all detailed description herein reciting the principles, aspects, and embodiments of the present disclosure as well as specific embodiments thereof are intended to encompass both structural and functional equivalents thereof. Additionally, it should be understood that such equivalents include both currently known equivalents as well as equivalents to be developed in the future, that is, any elements developed to perform the same function regardless of its structure.

The foregoing objects, features and advantages will be more obvious through the following detailed description associated with the accompanying drawings, and accordingly, the technological concept of the present disclosure can be easily implemented by a person having ordinary skill in the art to which the present disclosure pertains. In describing the present disclosure, moreover, the detailed description will be omitted when a specific description for publicly known technologies to which the present disclosure pertains is judged to obscure the gist of the present disclosure.

Hereinafter, a preferred embodiment according to the present disclosure will be described in detail with reference to the accompanying drawings.

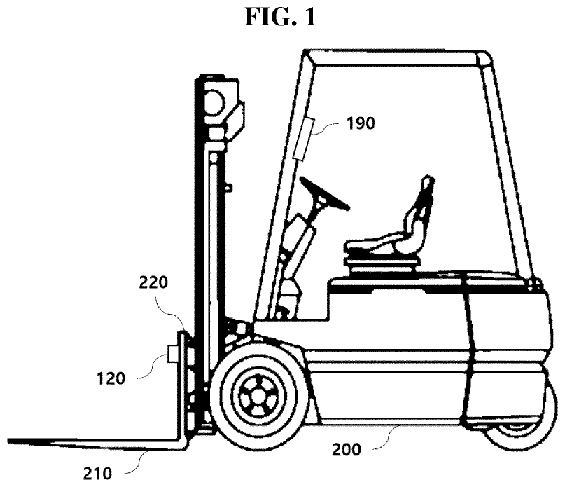

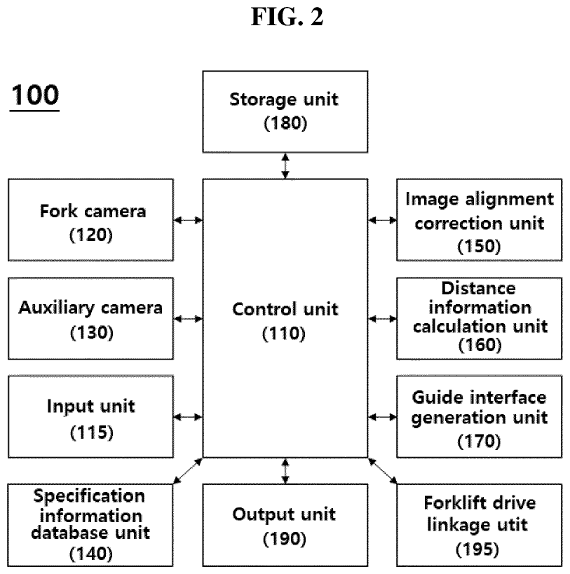

FIG. 1 is a diagram showing a forklift mounted with an image analysis-based forklift interface providing device according to an embodiment of the present disclosure, and FIG. 2 is a block diagram for explaining in more detail an image analysis-based forklift interface providing device according to an embodiment of the present disclosure.

First, referring to FIG. 1, a forklift interface providing device 100 according to an embodiment of the present disclosure may be provided in coupling with a typical system of a forklift 200, and particularly, may include a fork camera 120 mounted on a fork 210 or a fork connection portion 220 of the forklift to collect fork image information, and an output unit 190 may be provided on a front side of a driver's seat to output image information including a guide interface according to an embodiment of the present disclosure.

Here, the fork camera 120 may be mounted at an end portion of the fork 210 or the fork connection portion 220 at which the fork 210 is connected to a carriage of the forklift 200, and preferably mounted at a position defined in a specification database, such as a hook portion of the fork connection portion 220 in order to calculate accurate specified height information

Furthermore, the forklift interface providing device 100 may be coupled to a drive control system of the forklift 200 to identify the specification information and drive information of the forklift, and output a control mode, control status information or the like on the forklift 200 through the output unit 190. The output unit 190 may output guide information to guide the driver in the operation of the forklift through a screen or voice, thereby allowing the forklift driver to load or unload a pallet in front or accurately check surrounding conditions or distance information by referring to the guide information.

In order to configure such guide information, the forklift interface providing device 100 may accurately calculate distance information to the front through image analysis of the fork camera 120, and may accurately correct an error in image information using a specification information index corresponding to the forklift 200 to output a center-aligned image, and therefore, specific configurations for implementing this will be described in more detail later.

Referring to FIG. 2, the interface providing device 100 according to an embodiment of the present disclosure includes a control unit 110, an input unit 115, a fork camera 120, an auxiliary camera 130, a specification information database unit 140, an image alignment correction unit 150, a distance information calculation unit 160, a guide interface generation unit 170, a storage unit 180, and a forklift drive linkage unit 195.

The control unit 110 may include one or more microprocessors to control an overall operation of the interface providing device 100.

Furthermore, the fork camera 120 may include one or more camera modules that collect fork image information for configuring the guide interface and transmit the collected fork image information to the control unit 110. As described above, the fork camera 120 may be mounted at an end portion of the fork 210 or the fork connection portion 220 at which the fork 210 is connected to a carriage of the forklift 200, and preferably mounted at a position defined in a specification database, such as a hook portion of the fork connection portion 220 in order to calculate accurate specified height information

In addition, the auxiliary camera 130 may be a typical camera that collects surrounding images other than fork images, and the surrounding image information may be output in some areas of the guide interface according to an embodiment of the present disclosure. Additionally, the auxiliary camera 130 may include a plurality of cameras, and surrounding image information output from the auxiliary camera 130 may include an around view, a rear camera image, and the like.

The input unit 115 generates input data for operation control and information input of the interface providing device 100 for the driver. The input unit 115 may be configured with a key pad, a dome switch, a touch pad (static pressure/electrostatic), a jog wheel, a jog switch, and the like.

The specification information database unit 140 may store and manage preset specification information of the forklift. In addition, the specification information database unit 140 may acquire specification database information indexed in the specification information database unit 140 according to forklift information set through the input unit 115, and configure the acquired information as specification information for configuring the guide interface to be stored and managed in the storage unit 180.

Here, the specification information may include specification information of a forklift fork. The forklift fork may be mapped to any one of specification lists corresponding to the industry association standard database, and may include the length, type, protruding length, and width of the fork, and in particular, may include detailed dimensional information for each fork position.

Accordingly, while installing the interface providing device 100, the driver or a product installer may set the fork to any one of standardized specifications indexed in the specification information database unit 140, or may input forklift product information and process it to be indexed in the specification information database unit 140.

Additionally, position information of the fork camera 120 may be preset in response to the specification information of the specification information database unit 140. For example, the fork camera 120 may be provided at an upper hook connection portion of a right fork, and height information corresponding to the upper hook connection portion may be selectively input, or may be automatically determined by a value pre-indexed in the specification information database unit 140.

Furthermore, the image alignment correction unit 150 aligns and corrects a center line of the fork image information collected from the fork camera 120 using the set specification information. Typically, fork image information must be constructed from a viewpoint positioned at the center of both forks, such as a front camera.

However, the fork camera 120 according to an embodiment of the present disclosure may be provided to be biased toward any one of the forks 210 or the fork connection portion 220, and therefore, in order to align an image screen to the center, the image alignment correction unit 150 identifies the position information (a right fork or a left fork) of the fork camera 120 mapped to the specification information of the forklift, verifies the fork width information of the specification information of the forklift corresponding to the position information, and performs alignment around the fork image screen using the verified fork width and position information of the camera 120.

In addition, the specification information database unit 140 may further store focal length information of the fork camera. The focal distance information may be used to calculate distance information.

Furthermore, the distance information calculation unit 160 identifies object information from the center-aligned fork image information, and calculates distance information corresponding to the identified object information using the specification information of the specification information database unit 140 and the object information.

Here, a method of identifying object information from image information may use well-known deep learning image learning and analysis technologies such as convolutional neural network (CNN), and may calculate pixel size information corresponding to the identified object information.

Accordingly, the distance information calculation unit 160 may predict pixel size information, which is a width on a currently aligned image plane, as an actual size using pixel size information, actual size information of the forklift fork acquired from the specification information of the actual specification information database unit 140, and the focal length information of the fork camera 120, and may calculate actual distance information to the front using a trigonometric function according to the protruding length information and height information of the fork, and the height information of the fork camera 120 acquired from the specification information.

That is, the distance information calculation unit 160 according to an embodiment of the present disclosure may accurately calculate actual distance information from image information for providing a front fork image, thereby allowing a distance information guide interface to be configured using only the fork camera 120 without a separate distance measurement sensor.

Furthermore, the guide interface generation unit 170 generates a guide interface for driving a forklift using the distance information and the aligned fork image information. The guide interface may include a first alignment interface for fork alignment and a second alignment interface for pallet alignment, and may induce the first and second alignment interfaces to match so as to facilitate the insertion of a forklift into a pallet.

In addition, the guide interface may calculate and display a remaining distance according to the distance information, thereby allowing the driver to numerically check in advance how far he or she is away from a target pallet.

Furthermore, the distance information may be used for sensing an object in front and outputting a notification, and thus the guide interface generation unit 170 may construct a notification message based on the distance information to output the notification message through a voice output unit or display unit of the output unit 190.

For example, the guide interface generation unit 170 may output a beep sound that changes at regular intervals according to a remaining distance calculated from distance information, through the output unit 190, or may output a danger icon that gradually grows larger according to the remaining distance calculated from the distance information through the output unit 190.

Meanwhile, the forklift drive linkage unit 195 may collect driving status information of the system of the forklift 200 to transmit the collected information to the control unit 110, and acquire forklift driving command information according to the processing of the control unit 110 by the driving of each module unit to transmit the acquired driving command information to the forklift 200.

For example, the control unit 110 may generate a loading or unloading control command for the forklift or generate a setting command such as an automatic mode according to a user's input through the input unit 115 corresponding to the guide interface to transmit the generated command to the forklift drive linkage unit 195, and may collect the system status information of the forklift drive linkage unit 195 to transmit the collected information to the guide interface generation unit 170, thereby processing surrounding information such as auxiliary camera images to be output together on the guide interface.

Meanwhile, the storage unit 180 may store a program for operating the control unit 110, and also temporarily store input/output data.

The storage unit 180 may include a storage medium having at least one type of a flash memory type, a hard disk type, a multimedia card micro type, a card type memory (e.g., SD or XD memory, etc.), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk.

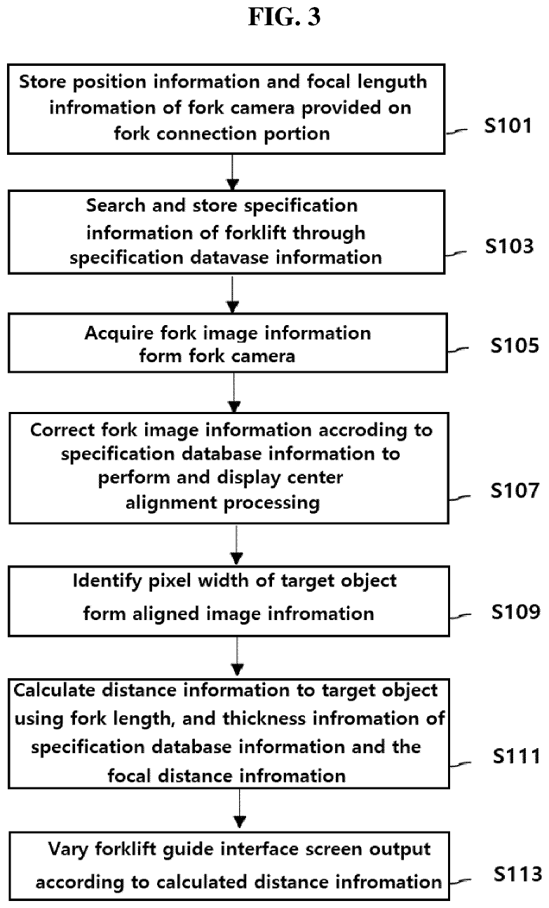

FIG. 3 is a flowchart for explaining in more detail an operation of an image analysis-based forklift interface providing device according to an embodiment of the present disclosure.

Referring to FIG. 3, first, the interface providing device 100 sets the position information and focal length information of the fork camera 120 provided on the fork connection portion 220 to store the set information in the specification information database unit 140 (S101).

Furthermore, the interface providing device 100 searches and indexes a database in the specification information database unit 140 for specification information corresponding to forklift unique information, and stores the indexed specification information (S103).

Then, the interface providing device 100 acquires fork image information from the fork camera 120 (S105), and corrects the acquired fork image information according to the specification information of the specification information database unit 140 to perform center alignment processing on the corrected image information and then display the center-aligned image information through the output unit 190 (S107).

Furthermore, the interface providing device 100 identifies a pixel width of a front target object from the image information (S109), and calculates actual distance information to the target object using fork length, height, and thickness information acquired from the specification information of the specification information database unit 140 and the focal distance information of the fork camera 120 (S111).

Furthermore, the interface providing device 100 varies an interface screen output according to the calculated distance information through the guide interface generation unit 170 (S113).

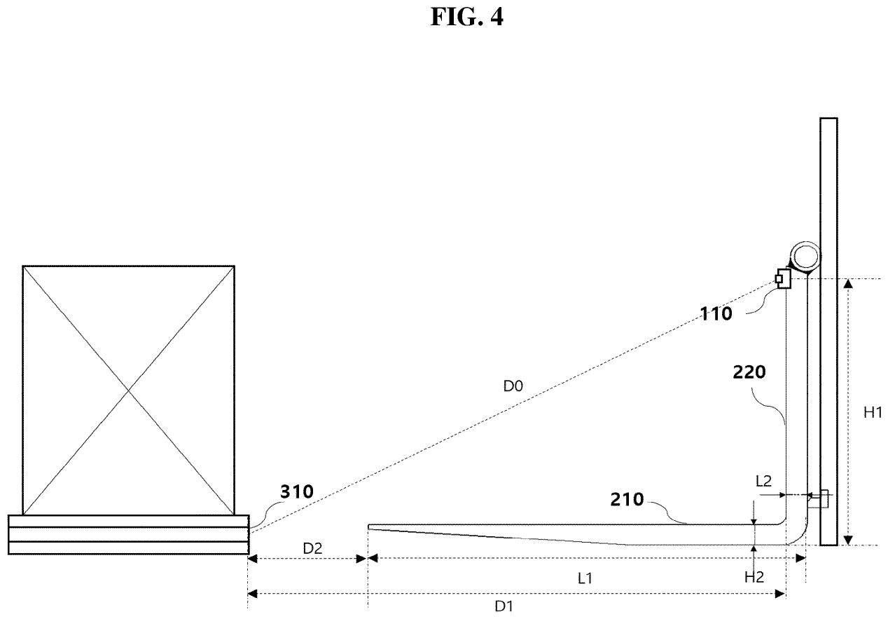

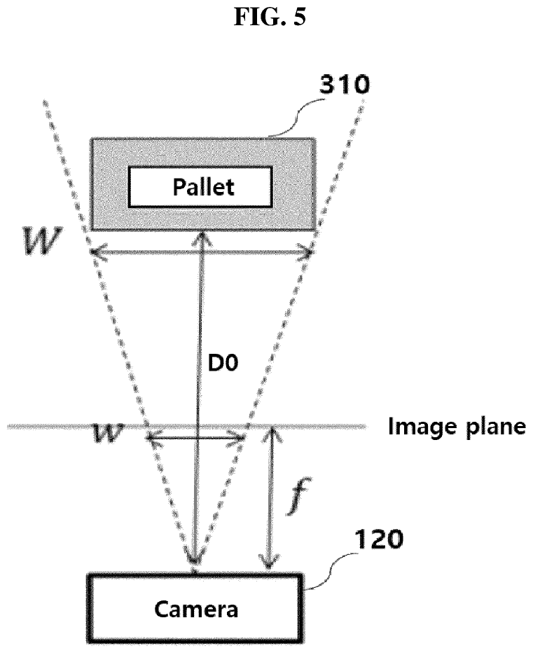

FIGS. 4 and 5 are diagrams for explaining a distance calculation process of an image analysis-based forklift interface providing device according to an embodiment of the present disclosure.

Referring to FIGS. 4 and 5, the specification information database unit 140 may store height information (H1) at which the fork camera 120 is provided, which may correspond to specified height information of the fork connection portion 220.

In addition, the specification information database unit 140 may further include fork protruding length information L1, fork thickness information H2, and thickness information L2 of the fork connection portion 220, and this respective length information may be used to calculate distance information D2 from the fork of the forklift to a pallet 310, which is a target object.

More specifically, first distance information DO, which is a straight-line distance to the target pallet 310, may be calculated from an image captured by the fork camera 120 and the focal length information. This is because, as shown in FIG. 5, an image plane is formed by a focal length f of the fork camera 120, and if a width of the actual palette 310 is W, and a pixel width of the palette 310 in the image is w, then W: D0=w:f, and thus the distance D0 from the actual camera to the palette 310 may be calculated by an arithmetic equation such as D0=(f×W)/w.

To this end, the specified width information W of the actual palette 310 may be pre-stored in the specification information database unit 140, and may also be acquired by matching according to image object identification.

Accordingly, when D0 is calculated, an initial length D1 may be calculated through a calculation such as a Pythagorean theorem calculation considering height information H1 or a trigonometric function based on predefined specification angles. Then, if the fork protruding length L1 is subtracted from D1, then the actual length D2 from a fork end portion to the pallet 310 may be calculated.

According to this method, the distance information calculation unit 160 may perform accurate distance calculation, and may also perform correction by additionally using values such as H2, L2, and the like, which are thicknesses for respective positions, in order to perform more accurate position calculations.

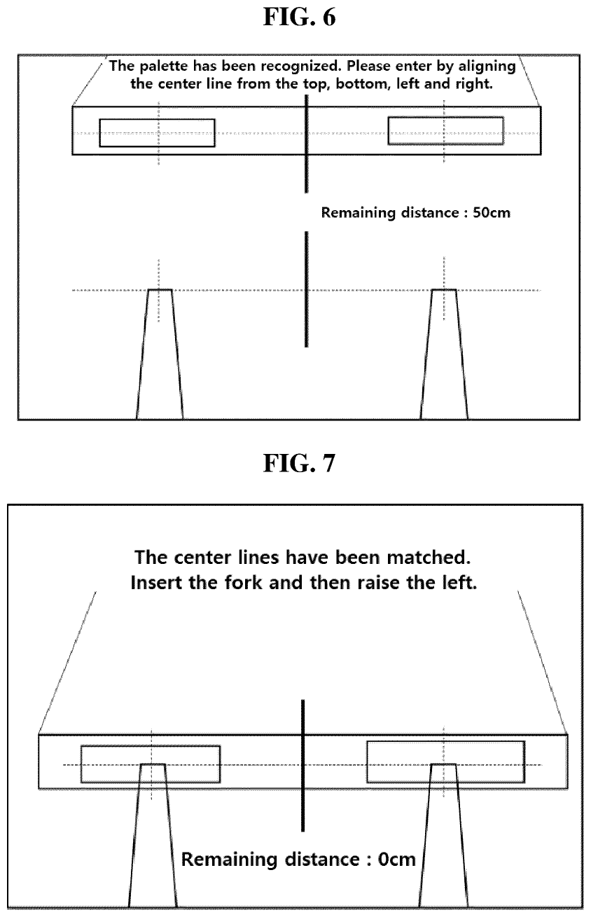

FIGS. 6 and 7 are exemplary diagrams of image analysis-based forklift guide interface screens according to an embodiment of the present disclosure.

As shown in FIGS. 6 and 7, the guide interface generation unit 170 may align and provide front fork images, and accurately calculate actual distance information on the aligned fork image information and output it as a remaining distance message.

In addition, the guide interface generation unit 170 may generate a guide interface for driving a forklift using the distance information and the aligned fork image information, and therefore, the guide interface may include a first cross-shaped alignment interface disposed on a fork for fork alignment and a second cross-shaped alignment interface disposed on a hole of a pallet for pallet alignment, and may induce the first and second alignment interfaces having two cross shapes to match so as to facilitate the insertion of the forklift into the pallet.

Additionally, the guide interface generation unit 170 may output a fork insert and lift guide message when the center lines match, thereby improving the driver's convenience.

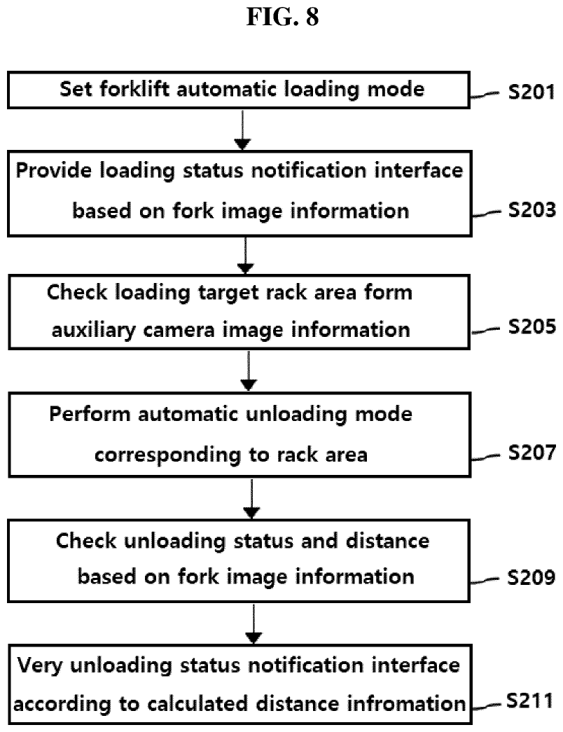

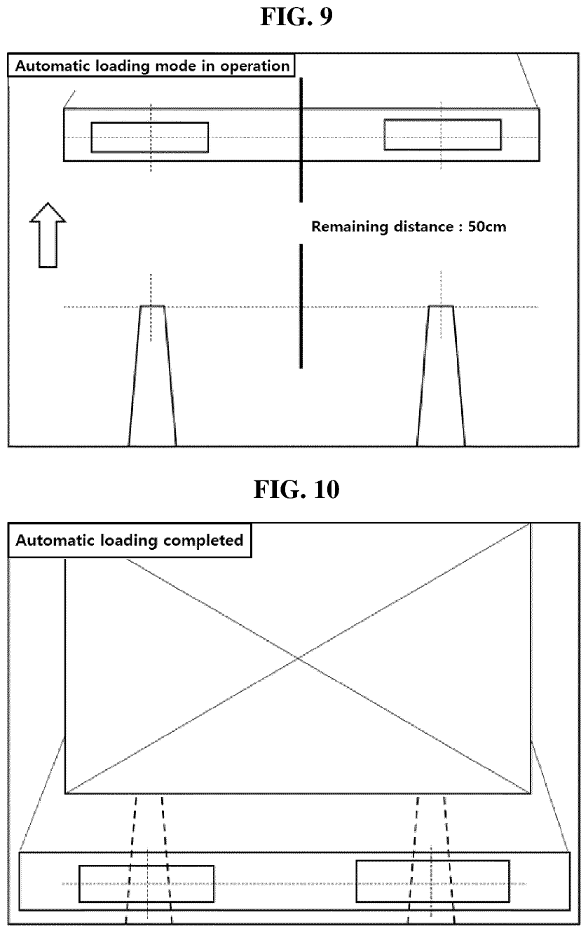

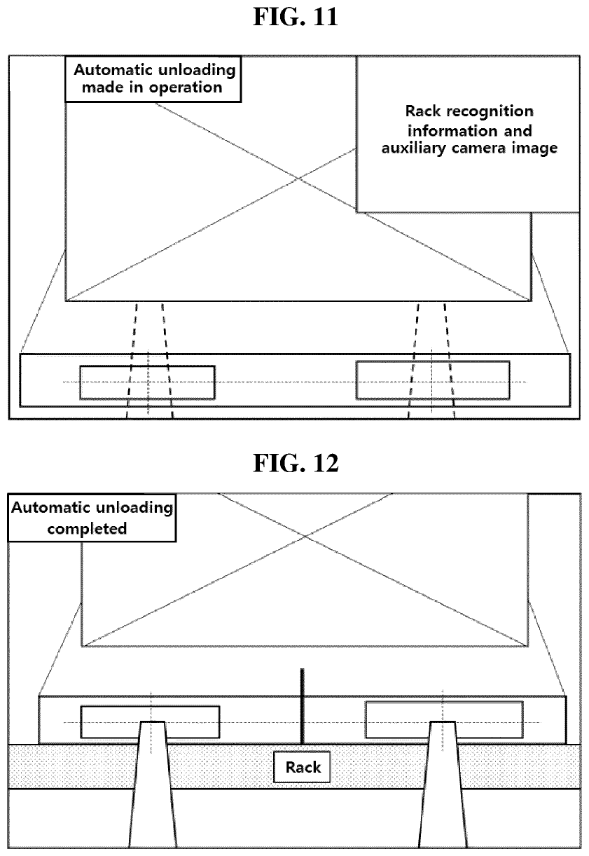

FIG. 8 is a flowchart for explaining an operation of an image analysis-based forklift interface providing device based on image analysis according to another embodiment of the present disclosure, and FIGS. 9 to 12 are exemplary diagrams of forklift guide interface screens for respective steps corresponding thereto.

Referring to FIGS. 8 to 12, the system of forklift 200 may be provided with an automatic loading mode and an automatic unloading mode. This may be driven by an image analysis module, a sensor module, and the like provided in the system of the forklift 200, and automatic loading and unloading functions may be processed according to rack position information acquired according to an image analysis. The interface providing device 100 according to an embodiment of the present disclosure may configure and provide an interface of the above-described guide interface generation unit 170 in conjunction with the automatic loading and unloading function processing, thereby efficiently performing a guide for a functional operation.

More specifically, when the automatic loading mode is first set in the system of the forklift 200 (S201), the interface providing device 100 provides a loading status notification interface based on fork image information (S203).

To this end, the guide interface generation unit 170 may collect loading mode information and loading status information from the drive linkage unit 195, and may calculate distance information to provide the calculated distance information through the guide interface. In this regard, examples of interface screens are illustrated in FIGS. 9 and 10.

Furthermore, the guide interface generation unit 170 may check a loading target rack area from auxiliary camera image information to output the checked loading target rack area as well on the guide interface (S205). In this regard, an example of a screen is illustrated in FIG. 11.

In addition, when an automatic unloading mode is set in the system of the forklift 200 (S207), the interface providing device 100 checks an unloading status and distance based on the fork image information and provides an unloading status notification interface (S209). Moreover, the unloading status notification interface may be varied according to the calculated distance information (S211). Examples of these screens may be illustrated through FIGS. 11 and 12.

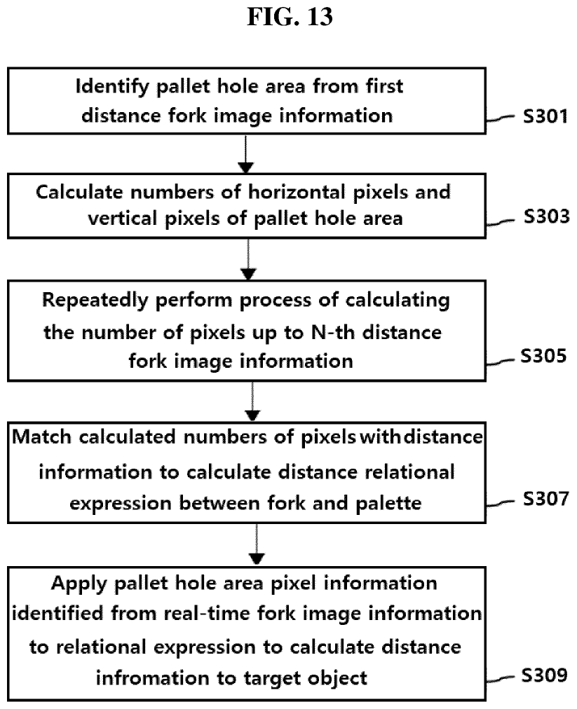

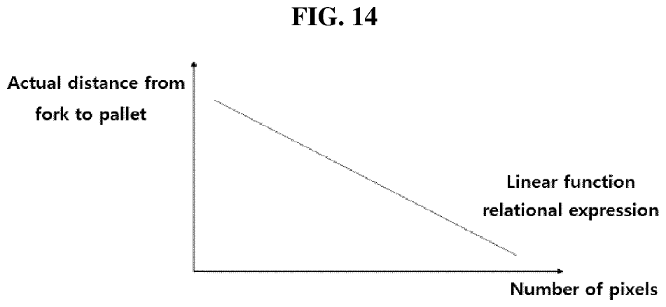

Meanwhile, FIGS. 13 and 14 are diagrams for explaining a distance calculation process of an image analysis-based forklift interface providing device according to another embodiment of the present disclosure.

Referring to FIGS. 13 and 14, first, the distance information calculation unit 160 identifies a pallet hole area from fork image information at a preset first distance (S301).

Here, it may be illustrated that the preset first distance is 1 meter. Additionally, the palette hole area may be identified as a rectangular or circular area forming a set of black areas where color or brightness information is identified as being below a threshold.

Furthermore, the distance information calculation unit 160 calculates numbers of horizontal pixels and vertical pixels of the pallet hole area in the image to calculate a total number of pixels corresponding to the pallet hole area (S303).

In addition, the distance information calculation unit 160 may repeatedly perform a process of calculating the numbers of pixels corresponding to the pallet hole area up to the fork image information of an N-th distance (S305). Here, the N-th distance may be a value that increases in the unit of 1 meter, and when the first distance is 1 meter, the value may be increased sequentially such that a second distance is 2 meters, a third distance is 3 meters, a fourth distance is 4 meters, a fifth distance is 5 meters, an N-th distance is N meters, and the like. This repetitive performance process may be called a training process, and a relational expression to be described later may be calculated according to training.

Then, the distance information calculation unit 160 matches the calculated numbers of pixels with the distance information to calculate a distance relational expression between the fork camera 120 and the palette (S307).

Here, referring to FIG. 14, the distance information calculation unit 160 according to an embodiment of the present disclosure may calculate a distance relational expression from the fork camera 120 to the palette relative to the number of pixels in the form of a relational expression such as a linear function equation. By calculating a slope between each distance value that increases in units of meters and a number of pixels that decreases as the distance increases, a distance relational expression corresponding to the relevant slope may be calculated. The calculated relational expression is stored in the storage unit 180.

Then, referring to FIG. 13 again, the distance information calculation unit 160 may apply pallet hole area pixel information identified from real-time fork image information to a relational expression to calculate distance information to the pallet, which is a target object (S309).

This distance information calculation method may be configured to replace the steps S109 to S111 described above, and in this case, it may be processed by a relational expression between a number of pixels compared to pre-calibrated distance information, and thus distance information may be calculated without specification database information, and accuracy may be guaranteed regardless of product specifications.

Meanwhile, various embodiments described herein may be implemented in a computer-readable recording medium, for example, using software, hardware, or a combination thereof. According to hardware implementation, the embodiments described herein may be implemented using at least one of application specific integrated circuits (ASICs), digital signal processors (DSPs), digital signal processing devices (DSPDs), programmable logic devices (PLDs), and field programmable gate arrays (FPGAs), processors, controllers, micro-controllers, microprocessors, and electrical units for performing functions. In some cases, such embodiments may be implemented by a control unit.

Furthermore, the embodiments described above may be implemented as hardware elements, software elements, and/or a combination of hardware elements and software elements. For example, the devices, methods and elements described in the embodiments may be implemented using, for example, one or more general-purpose or special-purpose computers, such as a processor, a controller, a central processing unit (CPU), a graphics processing unit (GPU), an arithmetic logic unit (ALU), a digital signal processor, a microcomputer, a field programmable gate array (FPGA), a programmable logic unit (PLU), a microprocessor, application specific integrated circuits (ASICs), or any other device capable of executing and responding to instructions.

Furthermore, the foregoing method according to the present disclosure may be produced as a program to be executed on a computer and stored in a computer-readable recording medium, and examples of computer-readable recording media include a ROM, a RAM, a CD-ROM, a magnetic tape, a floppy disk, an optical data storage device, and the like.

The computer-readable recording medium may be distributed over computer systems connected via a network, and stored and executed as computer-readable codes in a distributed manner. Furthermore, functional programs, codes, and code segments for implementing the method may be easily inferred by programmers in the technical field to which the present disclosure pertains.

In addition, while the preferred embodiments of the present disclosure have been shown and described above, it will be of course understood by those skilled in the art that various modifications may be made without departing from the gist of the disclosure as defined in the following claims, and it is to be noted that those modifications should not be understood individually from the technical concept and prospect of the present disclosure.

1. A forklift interface providing device, the device comprising:
a fork camera provided in a fork of a forklift;
a guide interface generation unit that constructs fork image information of the fork camera into a guide interface;
a distance information calculation unit that calculates distance information to a target object from pixel information of the fork image information; and
an output unit that outputs the guide interface using the distance information.

2. The device of claim 1, wherein the guide interface generation unit varies the guide interface according to the distance information.

3. The device of claim 2, wherein the guide interface generation unit outputs a notification message corresponding to the distance information.

4. The device of claim 1, wherein the distance information calculation unit applies pallet hole area pixel information identified from the fork image information to a pre-trained relational expression to calculate distance information to the target object.

5. The device of claim 4, wherein the distance information calculation unit applies a number of pixels in a pallet hole area of the fork image information to a linear function relational expression in which distance information and a number of pixels are pre-matched to calculate the distance information.

6. The device of claim 1, wherein the guide interface generation unit generates a guide interface comprising a first alignment interface for fork alignment and a second alignment interface for pallet alignment, and
wherein the guide interface induces the first and second alignment interfaces to match so as to induce the insertion of a forklift into a pallet.

7. The device of claim 1, wherein the guide interface generation unit provides a status notification interface corresponding to an automatic loading or unloading mode of the forklift.

8. The device of claim 1, further comprising:
a specification information database unit that manages the specification information of the forklift,
wherein the guide interface generation unit aligns fork image information of the fork camera according to the specification information.

9. The device of claim 8, wherein the target object is a palette, and
wherein the distance information calculation unit calculates first distance information using an image pixel width and a specified actual width of the palette on an image plane according to focal length information of the fork camera, and calculates the distance information by subtracting fork length information acquired from the specification information database unit from the first distance information.

10. A method of operating a forklift interface providing device, the method comprising:
constructing fork image information of a fork camera provided in a fork of a forklift into a guide interface;
calculating distance information to a target object from pixel information of the fork image information; and
outputting the guide interface using the distance information.

11. The method of claim 10, wherein the generating of the guide interface comprises varying the guide interface according to the distance information.

12. The method of claim 11, wherein the generating of the guide interface comprises outputting a notification message corresponding to the distance information.

13. The method of claim 10, wherein the calculating of the distance information comprises applying pallet hole area pixel information identified from the fork image information to a pre-trained relational expression to calculate distance information to the target object.

14. The method of claim 13, wherein the calculating of the distance information comprises applying a number of pixels in a pallet hole area of the fork image information to a linear function relational expression in which distance information and a number of pixels are pre-matched to calculate the distance information.

15. The method of claim 10, wherein the generating of the guide interface comprises generating a guide interface comprising a first alignment interface for fork alignment and a second alignment interface for pallet alignment, and
wherein the guide interface induces the first and second alignment interfaces to match so as to induce the insertion of a forklift into a pallet.

16. The method of claim 10, wherein the generating of the guide interface comprises providing a status notification interface corresponding to an automatic loading or unloading mode of the forklift.

17. The method of claim 10, further comprising:
managing the specification information of the forklift,
wherein the generating of the guide interface comprises aligning fork image information of the fork camera according to the specification information.

18. The method of claim 17, wherein the target object is a palette, and
wherein the calculating of the distance information comprises calculating first distance information using an image pixel width and a specified actual width of the palette on an image plane according to focal length information of the fork camera, and calculating the distance information by subtracting fork length information acquired from the specification information database unit from the first distance information.

19. A computer program stored in a computer-readable recording medium for executing the method according to claim 10 on a computer.
